(19) United States
(12) Patent Application Publication
(10) Pub. No.: US 2025/0218649 A1
(43) Pub. Date: Jul. 3, 2025

(54) COIL DEVICE

(71) Applicant: TDK Corporation, Tokyo (JP)

(72) Inventors: Kosuke ENDO, Tokyo (JP); Shohei ABE, Tokyo (JP); Satoshi SUGIMOTO, Tokyo (JP)

(73) Assignee: TDK Corporation, Tokyo (JP)

(21) Appl. No.: 18/979,891

(22) Filed: Dec. 13, 2024

(30) Foreign Application Priority Data
Dec. 28, 2023 (JP) 2023-223618

(51) Int. Cl. H01F 27/28; H01F 27/24; H01F 27/29

(52) U.S. Cl. CPC H01F 27/2823; H01F 27/24; H01F 27/29

(57) ABSTRACT

A coil device includes a core containing a magnetic material and having a mounting surface and a side surface extending in a direction perpendicular to the mounting surface, and a wire including a winding portion disposed inside the core and a lead-out portion drawn out from the winding portion. The lead-out portion includes a proximal portion continuing to the winding portion and a flattened portion continuing to the proximal portion and being squeezed flat. The flattened portion includes an embedded portion disposed inside the core and a terminal portion having a plating layer and being disposed outside the core. The embedded portion extends diagonally from the proximal portion to the side surface. The terminal portion is exposed from the core at a central portion of the side surface in the direction perpendicular to the mounting surface. The terminal portion extends from the central portion to the mounting surface.

### TECHNICAL FIELD

The present disclosure relates to a coil device.

### BACKGROUND

For example, Patent Document 1 discloses a coil device that can be used as an inductor. The coil device of Patent Document 1 includes a winding portion disposed inside a core and leader parts (lead-out portions) drawn out from the winding portion. Each leader part includes a flattened portion squeezed flat and is drawn out from the winding portion towards a side surface of the core. The flattened portion is partly disposed inside the core. A remaining portion of the flattened portion is exposed from the core and extends along the side surface and a mounting surface of the core.

At the flattened portion disposed on the mounting surface, the coil device of Patent Document 1 can be connected to a mounting substrate using a conductive joining material (e.g., solder or a conductive adhesive). Because the flattened portion functions as a terminal of the coil device in such a manner, a need for providing the coil device with a separate terminal is eliminated, which can reduce the size of the coil device and reduce the number of parts.

Patent Document 1: JP Patent Application Laid Open No. 2009-123927

### SUMMARY

Meanwhile, the flattened portion of the coil device of Patent Document 1 is drawn out along an outer circumferential surface of the winding portion so as to be partially adjacent to the winding portion inside the core. Thus, reduction of the distance between the flattened portion and the winding portion due to reduction in the size of the coil device may cause a short circuit between the flattened portion and the winding portion. Also, because the flattened portion, which is disposed at the side surface of the core, of the coil device of Patent Document 1 has a small area, a fillet (e.g., solder) is less readily formed at the flattened portion. Thus, it is unfortunately difficult to ensure mounting strength of the coil device.

The present disclosure provides a coil device that readily ensures mounting strength and can prevent a short circuit between a lead-out portion and a winding portion.

A coil device of the present disclosure includes:
a core containing a magnetic material and having a mounting surface and a side surface extending in a direction perpendicular to the mounting surface, and
a wire including a winding portion disposed inside the core and a lead-out portion drawn out from the winding portion,
wherein
the lead-out portion includes a proximal portion continuing to the winding portion and a flattened portion continuing to the proximal portion and being squeezed flat,
the flattened portion includes an embedded portion disposed inside the core and a terminal portion having a plating layer and being disposed outside the core,
the embedded portion extends diagonally from the proximal portion to the side surface,
the terminal portion is exposed from the core at a central portion of the side surface in the direction perpendicular to the mounting surface, and
the terminal portion extends from the central portion of the side surface to the mounting surface.

The embedded portion may extend from the proximal portion to a level of a central portion of the winding portion in the direction perpendicular to the mounting surface.

The embedded portion may extend diagonally from the proximal portion to the side surface without a bend at a right angle.

The proximal portion may include a sloping portion; and the sloping portion may thin towards the flattened portion in a section perpendicular to the mounting surface and the side surface.

The lead-out portion may be bent at a border portion between the proximal portion and the flattened portion; and the lead-out portion may have a radius of curvature larger than a thickness of the flattened portion at the border portion.

The wire may include a round wire or an edgewise wound rectangular wire; and the winding portion may include an insulating coating.

The winding portion may have a circular outer circumferential shape viewed from the direction perpendicular to the mounting surface.

A winding axis direction of the winding portion may slope with respect to the direction perpendicular to the mounting surface.

### BRIEF DESCRIPTION OF THE DRAWING(S)

FIG. 1A is a perspective view of a coil device of a first embodiment.

FIG. 1B is a perspective view of an internal structure of the coil device shown in FIG. 1A.

FIG. 2 is a perspective view of a wire shown in FIG. 1B.

FIG. 3 is a plan view of the coil device shown in FIG. 1B.

FIG. 4A is a sectional view along a line IVA-IVA shown in FIG. 3.

FIG. 4B is a sectional view of a modified example of lead-out portions shown in FIG. 4A.

FIG. 5A is a plan view of a method of manufacturing the coil device shown in FIG. 1A.

FIG. 5B is a plan view of a step subsequent to the step shown in FIG. 5A.

FIG. 5C is a plan view of a step subsequent to the step shown in FIG. 5B.

FIG. 5D is a plan view of a step subsequent to the step shown in FIG. 5C.

FIG. 5E is a plan view of a step subsequent to the step shown in FIG. 5D.

FIG. 6A is a sectional view of a coil device of a second embodiment.

FIG. 6B is a sectional view of a modified example of a winding portion shown in FIG. 4A or FIG. 6A.

### DETAILED DESCRIPTION

Hereinafter, embodiments of the present disclosure are described with reference to the drawings. Illustrations in the drawings are only schematically and exemplarily provided for understanding of the present disclosure; and the illustrated appearance, dimensional ratios, etc. may be different from actual ones. The present disclosure is not limited to the following embodiments.

### First Embodiment

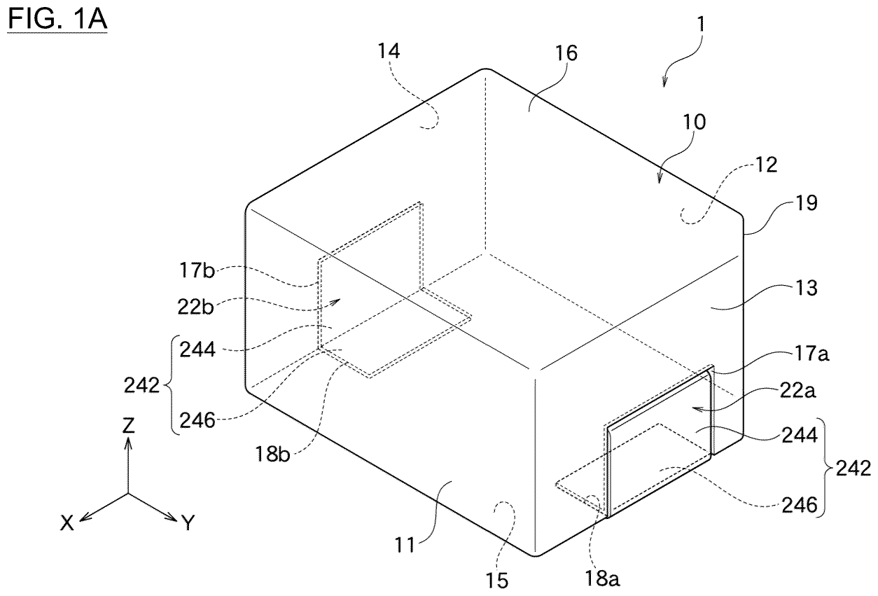

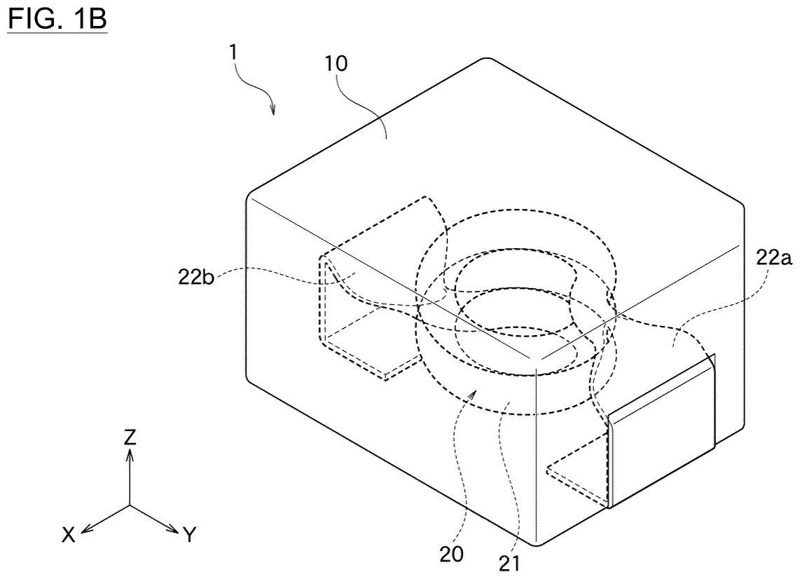

A coil device 1 shown in FIG. 1A is a surface mounting type inductor and is mounted on, for example, a power supply circuit of electronics. The coil device 1 includes a core 10 and a wire 20 (FIG. 1B). The core 10 may have any shape but has a substantially hexahedron shape in the example shown in FIG. 1A. The core 10 may have a cylindrical shape, an elliptic cylindrical shape, an n-hedron shape (n≥7), or any other polyhedral shape. The core 10 includes a first side surface 11, a second side surface 12, a third side surface 13, a fourth side surface 14, a mounting surface 15, and an opposite mounting surface 16.

A ridge between the second side surface 12 and the third side surface 13 is chamfered. The ridge between the second side surface 12 and the third side surface 13 has a chamfered portion 19. Providing the core 10 with the chamfered portion 19 makes it easier to identify an orientation of the core 10. However, the chamfered portion 19 is not essential and may be omitted.

The first side surface 11 and the second side surface 12 face each other. The third side surface 13 and the fourth side surface 14 face each other. The mounting surface 15 and the opposite mounting surface 16 face each other.

In FIG. 1A and the like, the X-axis is an axis extending along a direction in which the first side surface 11 and the second side surface 12 face each other. The Y-axis is an axis extending along a direction in which the third side surface 13 and the fourth side surface 14 face each other. The Z-axis is an axis extending along a direction in which the mounting surface 15 and the opposite mounting surface 16 face each other (a direction perpendicular to the mounting surface 15).

The X-axis, the Y-axis, and the Z-axis are perpendicular to each other. In the following description, with regard to the X-axis, the Y-axis, and the Z-axis, a direction away from a center of the core 10 is referred to as an outward direction, and a direction towards the center of the core 10 is referred to as an inward direction. Also, the positive direction of the Z-axis is referred to as an upward direction, and the negative direction of the Z-axis is referred to as a downward direction. However, the upward direction in the Z-axis does not necessarily match a vertically upward direction; and the downward direction in the Z-axis does not necessarily match a vertically downward direction.

The core 10 may have any width in the X-axis direction. The width is, for example, 3.0 to 10.0 mm. The core 10 may have any length in the Y-axis direction. The length is, for example, 3.0 to 10.0 mm. The core 10 may have any thickness in the Z-axis direction (thickness of the core 10). The thickness is, for example, 2.0 to 10.0 mm.

The core 10 is made from a complex material including a magnetic material and a resin. Any method of forming the core 10 may be used. Examples of such methods include compaction molding, injection molding, and machining. In the present embodiment, the core 10 is a pressed body including the magnetic material and the resin. The magnetic material constituting the core 10 is not limited. Examples of such materials include ferrites (e.g., Ni—Zn based ferrites and Mn—Zn based ferrites) and metal magnetic materials. The resin constituting the core 10 is not limited. Examples of such resins include an epoxy resin and a phenol resin.

The core 10 has first recesses 17a and 17b and second recesses 18a and 18b. The first recess 17a and the second recess 18a are provided continuously from the third side surface 13 to the mounting surface 15. The first recess 17b and the second recess 18b are provided continuously from the fourth side surface 14 to the mounting surface 15.

The first recess 17a is recessed from the third side surface 13, and the first recess 17b is recessed from the fourth side surface 14. In the first recess 17a, a side portion 244 of a lead-out portion 22a described later is disposed. In the first recess 17b, a side portion 244 of a lead-out portion 22b described later is disposed. The first recess 17a or the first recess 17b has a width wider than that of the side portion 244 in the X-axis direction.

The second recesses 18a and 18b are recessed from the mounting surface 15. In the second recess 18a, a mounting portion 246 of the lead-out portion 22a described later is disposed. In the second recess 18b, a mounting portion 246 of the lead-out portion 22b described later is disposed. The second recess 18a or the second recess 18b has a width wider than that of the mounting portion 246 in the X-axis direction. The second recess 18a or the second recess 18b has a depth that is not larger than the thickness of the mounting portion 246. The first recesses 17a and 17b and the second recesses 18a and 18b are not essential and may be omitted from the core 10.

As shown in FIG. 1B, the wire 20 includes a winding portion 21, the lead-out portion 22a, and the lead-out portion 22b. The wire 20 is, for example, an insulation coated wire, in which a conductive core wire is coated with an insulating film (insulating coating). As the wire 20, for example, known wires, such as a polyamide-imide copper wire (AIW), a polyurethane copper wire (UEW), or a polyester copper wire (PEW), can be used. The wire may be made from any material. Examples of such materials include copper, a copper alloy, silver, and nickel. The wire 20 is a round wire but may be a rectangular wire (e.g., edgewise wound rectangular wire) or the like. The wire 20 may have any diameter. The diameter is, for example, 0.3 to 2.0 mm.

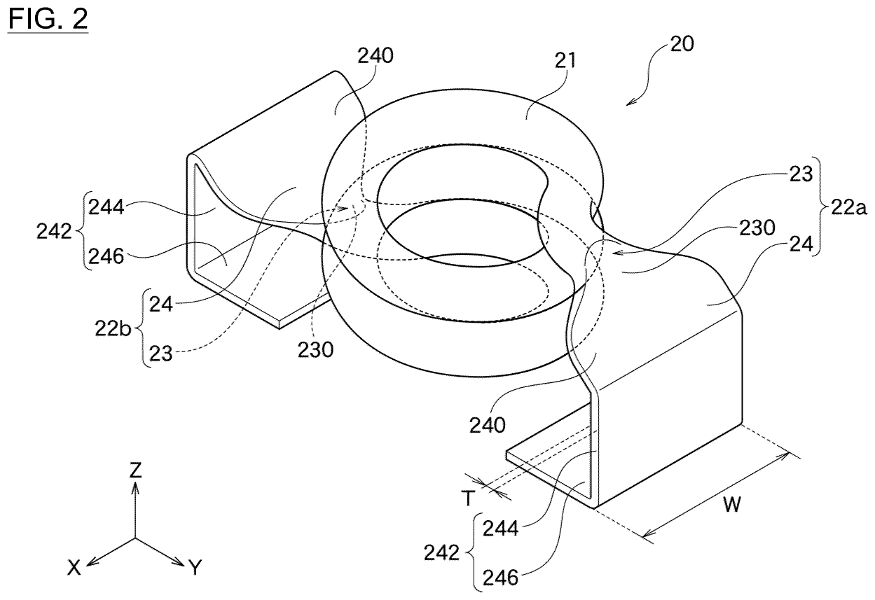

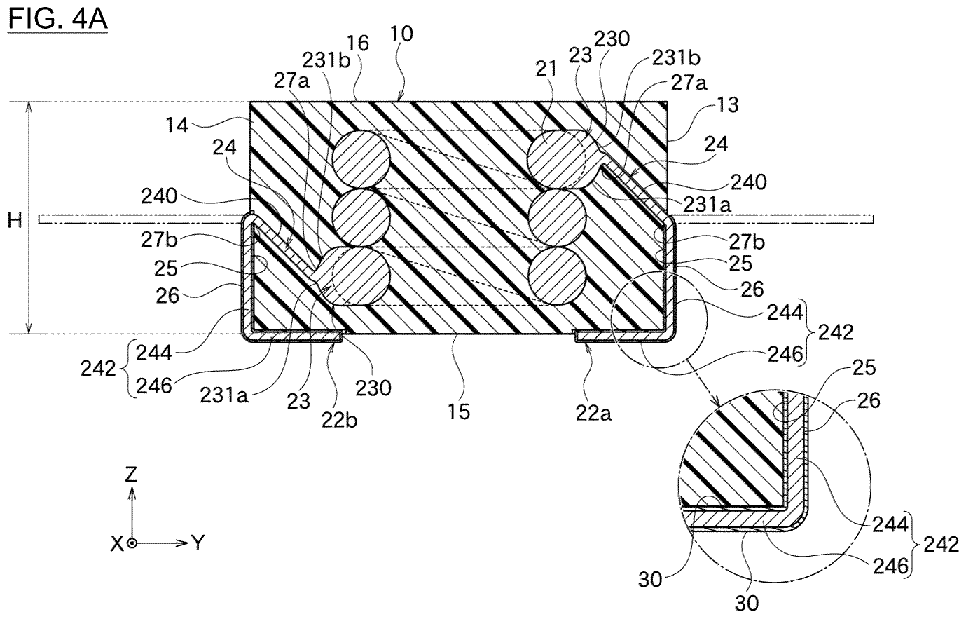

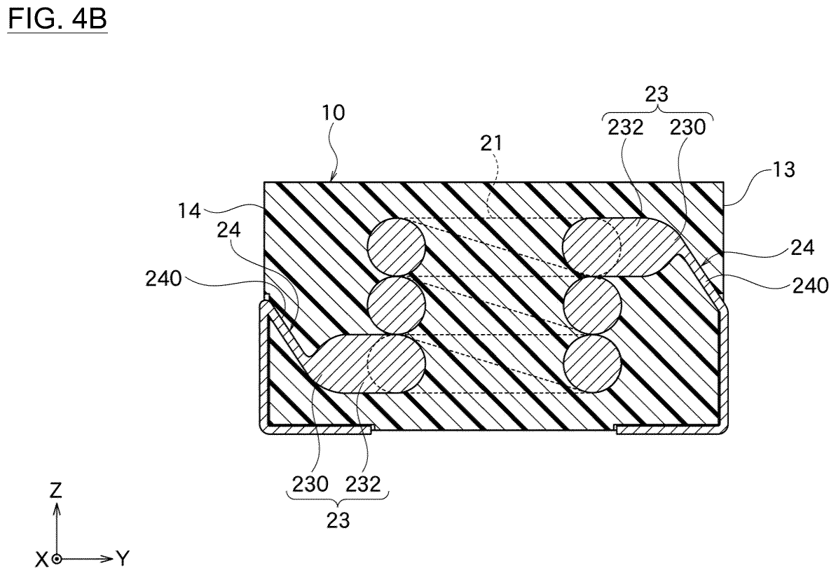

The winding portion 21 is an air core coil and is disposed inside the core 10. As shown in FIG. 2, the wire 20 is wound 2.5 turns spirally at the winding portion 21. A winding axis direction of the winding portion 21 corresponds to the Z-axis direction. The number of layers of the winding portion 21 in the winding axis direction (Z-axis direction) is three (see FIG. 4A). However, the number of turns of the wire 20 is not limited. The number of turns may be 1.5 turns or 3.5 turns or more. The number of layers of the winding portion 21 in the winding axis direction may be two or may be four or more. At the winding portion 21, a surface of the wire 20 is provided with the insulating film (insulating coating). Viewed from the direction perpendicular to the mounting surface 15 (Z-axis direction), the winding portion 21 has a circular outer circumferential shape; however, the winding portion 21 may have an oval outer circumferential shape or the like.

The lead-out portion 22a is drawn out from a third layer of the winding portion 21 in the winding axis direction. The lead-out portion 22b is drawn out from a first layer of the winding portion 21 in the winding axis direction oppositely from the lead-out portion 22a. Each of the lead-out portions 22a and 22b includes a proximal portion 23 and a flattened portion 24. As shown in FIG. 4A, the lead-out portion 22a includes an inner surface 25 facing the mounting surface 15 or the third side surface 13 and an outer surface 26 opposite the inner surface 25. The lead-out portion 22b includes the inner surface 25 facing the mounting surface 15 or the fourth side surface 14 and the outer surface 26 opposite the inner surface 25.

The proximal portion 23 and the flattened portion 24 are formed by squeezing (pressing or urging) the lead-out portion 22a or 22b. The flattened portion 24 is where the lead-out portion 22a or 22b is squeezed flat. By contrast, the proximal portion 23 is where the lead-out portion 22a or 22b (thickness between the inner surface 25 and the outer surface 26) gradually thins from the winding portion 21 to the flattened portion 24. In other words, the proximal portion 23 is, unlike the flattened portion 24, where the lead-out portion 22a or 22b is not completely squeezed. Details of the proximal portion 23 and the flattened portion 24 are provided below.

The proximal portion 23 has a tapered shape becoming narrower from the winding portion 21 to the side surface (third side surface 13 or fourth side surface 14) of the core 10. The proximal portion 23 is disposed inside the core 10. One end of the proximal portion 23 in its extending direction continues to the winding portion 21, and the other end of the proximal portion 23 in its extending direction continues to the flattened portion 24. The proximal portion 23 of the lead-out portion 22a is located at a level above a center of the core 10 in the Z-axis direction. The proximal portion 23 of the lead-out portion 22b is located at a level below the center of the core 10 in the Z-axis direction.

The proximal portion 23 includes a sloping portion 230. The sloping portion 230 is disposed inside the core 10. In a section perpendicular to the mounting surface 15 and the third side surface 13 (i.e., YZ section), the sloping portion 230 (thickness between the inner surface 25 and the outer surface 26) thins towards a border portion 27a between the proximal portion 23 and the flattened portion 24. The border portion 27a between the proximal portion 23 and the flattened portion 24 is disposed inside the core 10 and is not exposed from the core 10.

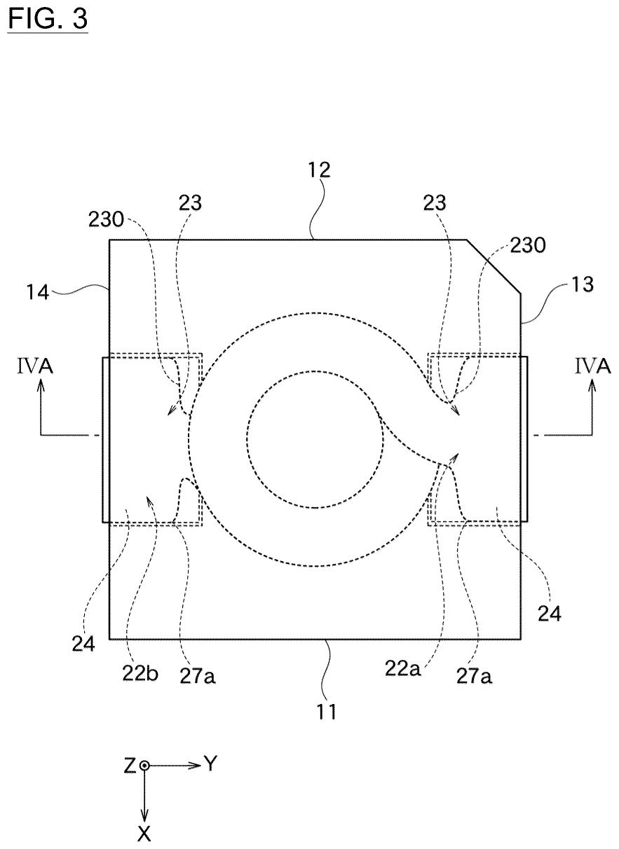

As shown in FIG. 3, viewed from the direction perpendicular to the mounting surface 15 (i.e., the Z-axis direction), the sloping portion 230 has a width in the X-axis direction gradually increasing towards the border portion 27a (FIG. 4A) between the proximal portion 23 (sloping portion 230) and the flattened portion 24

As shown in FIG. 4A, the inner surface 25 of the sloping portion 230 has a sloping surface 231a. To the border portion 27a between the proximal portion 23 and the flattened portion 24, the sloping surface 231a slopes opposite the mounting surface 15 (towards the opposite mounting surface 16 or upwards). At a center of the sloping surface 231a in the Y-axis direction, the sloping surface 231a may be at any sloping angle with respect to the mounting surface 15. The sloping angle is, for example, 10° or more and less than 90°, or 30° or more and less than 90°. The sloping surface 231a is a curved surface but may be a flat surface.

The outer surface 26 of the sloping portion 230 has a sloping surface 231b. To the border portion 27a between the proximal portion 23 and the flattened portion 24, the sloping surface 231b slopes towards the mounting surface 15 (downwards). At a center of the sloping surface 231b in the Y-axis direction, the sloping surface 231b may be at any sloping angle with respect to the opposite mounting surface 16. The sloping angle is, for example, 10° or more and less than 90°, or 30° or more and less than 90°. The sloping surface 231b is a curved surface but may be a flat surface.

At the proximal portion 23 (sloping portion 230), the film of the wire 20 is not peeled off; and a surface of the proximal portion 23 (sloping portion 230) is covered with the film. However, the film of the wire 20 may be peeled off at least at a part of the proximal portion 23 (sloping portion 230).

Although detailed illustration is omitted, the sloping portion 230 may have the sloping surface 231a and have no sloping surface 231b. Alternatively, the sloping portion 230 may have the sloping surface 231b and have no sloping surface 231a.

As shown in FIG. 4B, the proximal portion 23 may include, in addition to the sloping portion 230, a non-sloping portion 232. The non-sloping portion 232 is located between the winding portion 21 and the sloping portion 230. Unlike the sloping portion 230, the non-sloping portion 232 is where the lead-out portion 22a or 22b is not squeezed. Thus, at the non-sloping portion 232, the wire 20 has the same diameter as that of the wire 20 at the winding portion 21.

As shown in FIG. 4A, the flattened portion 24 continues to the proximal portion 23 and is squeezed flat. As shown in FIG. 2, the flattened portion 24 has a flat shape and is wider in the X-axis direction than the diameter Φ of the wire 20. The flattened portion 24 shown in FIG. 2 may have any width W in the X-axis direction. The width W is, for example, 1 to 10 mm. A ratio W/Φ of the width W of the flattened portion 24 in the X-axis direction to the diameter Φ of the wire 20 (the diameter of the wire 20 at the winding portion 21) is not limited. The ratio is, for example, 1<W/Φ≤10 or 2≤W/Φ≤8.

The flattened portion 24 may have any thickness. The thickness is, for example, 0.05 to 0.5 mm. A ratio T/Φ of the thickness T of the flattened portion 24 to the diameter Φ of the wire 20 (the diameter of the wire 20 at the winding portion 21) is not limited. The ratio is, for example, 1/15≤T/Q≤½ or 1/10≤T/Φ≤⅓.

The thickness of the flattened portion 24 (thickness between the inner surface 25 and the outer surface 26) is almost constant along an extending direction of the flattened portion 24. In this context, “almost constant” indicates that the thickness of the flattened portion 24 may have variation within several percent to tens of percent (not limited; e.g., ±10%, ±5%, or ±3%).

As shown in FIG. 4A, the lead-out portion 22a or 22b is bent at the border portion 27a between the proximal portion 23 and the flattened portion 24. At the border portion 27a between the proximal portion 23 and the flattened portion 24, the lead-out portion 22a may have any radius of curvature; and this radius of curvature is larger than the thickness of the flattened portion 24. At the border portion 27a between the proximal portion 23 and the flattened portion 24, the lead-out portion 22b may have any radius of curvature; and this radius of curvature is larger than the thickness of the flattened portion 24. However, in FIG. 4A, because the flattened portion 24 is illustrated relatively thick, the radius of curvature of the lead-out portion 22a or 22b at the border portion 27a is illustrated smaller than the thickness of the flattened portion 24. At the border portion 27a, the radius of curvature of the lead-out portion 22a or 22b may be equivalent to or smaller than the thickness of the flattened portion 24.

The flattened portion 24 includes an embedded portion 240 and a terminal portion 242. The embedded portion 240 is disposed inside the core 10. At the embedded portion 240, the film of the wire 20 is not peeled off; and a surface of the embedded portion 240 is covered with the film of the wire 20. The embedded portion 240 extends diagonally from the proximal portion 23 to the side surface (third side surface 13 or fourth side surface 14) of the core 10 so as to be bent with respect to the proximal portion 23. In the example shown in FIG. 4A, an entire region of the embedded portion 240 along its extending direction slopes with respect to the side surface of the core 10; however, a part of the embedded portion 240 along its extending direction may slope with respect to the side surface of the core 10.

The extending direction of the embedded portion 240 slopes with respect to the direction perpendicular to the mounting surface 15 (Z-axis direction). The extending direction of the embedded portion 240 slopes with respect to the winding axis direction of the winding portion 21 (Z-axis direction). The extending direction of the embedded portion 240 slopes with respect to the side surface (third side surface 13 or fourth side surface 14) of the core 10. The extending direction of the embedded portion 240 slopes with respect to the mounting surface 15 and the opposite mounting surface 16.

Near the border portion 27a between the proximal portion 23 and the flattened portion 24, the embedded portion 240 may be at any sloping angle with respect to the winding axis direction of the winding portion 21 (Z-axis direction) or the direction perpendicular to the mounting surface 15 (Z-axis direction). The sloping angle is, for example, 5° or more and less than 90°, 10° or more and less than 80°, or 20° or more and less than 70°. The same applies to a sloping angle near a border portion 27b between the embedded portion 240 and the terminal portion 242. The same applies to a sloping angle at a central portion of the embedded portion 240 in the extending direction.

Near the border portion 27a between the proximal portion 23 and the flattened portion 24, the embedded portion 240 may be at any sloping angle with respect to the side surface (third side surface 13 or fourth side surface 14) of the core 10. The sloping angle is, for example, 5° or more and less than 90°, 10° or more and less than 80°, or 20° or more and less than 70°. The same applies to a sloping angle near the border portion 27b between the embedded portion 240 and the terminal portion 242. The same applies to a sloping angle at the central portion of the embedded portion 240 in the extending direction.

The embedded portion 240 linearly extends from the proximal portion 23 to the side surface (third side surface 13 or fourth side surface 14) of the core 10. However, the embedded portion 240 may extend, from the proximal portion 23 to the side surface (third side surface 13 or fourth side surface 14) of the core 10, with a bend or a curve so as not to be bent at a right angle. In the present embodiment, “at a right angle” is not limited to the strict right angle (i.e., 90°); and the concept of “at a right angle” includes a state shifted by not more than several degrees (not limited; e.g., 3 degrees) with respect to the strict right angle.

The embedded portion 240 may, for example, be bent or curved, from the proximal portion 23 to the side surface (third side surface 13 or fourth side surface 14) of the core 10, so as to have a shape protruding towards the mounting surface 15 as a whole. Alternatively, the embedded portion 240 may be bent or curved, from the proximal portion 23 to the side surface (third side surface 13 or fourth side surface 14) of the core 10, so as to have a shape protruding towards the opposite mounting surface 16 as a whole. Alternatively, the embedded portion 240 may be bent or curved, from the proximal portion 23 to the side surface (third side surface 13 or fourth side surface 14) of the core 10, so as to undulate.

The sloping angle of the embedded portion 240 of the lead-out portion 22a with respect to the winding axis direction of the winding portion 21 (Z-axis direction) or the direction perpendicular to the mounting surface 15 (Z-axis direction) is almost equivalent to the sloping angle of the embedded portion 240 of the lead-out portion 22b with respect to the winding axis direction of the winding portion 21 (Z-axis direction) or the direction perpendicular to the mounting surface 15 (Z-axis direction). However, “almost equivalent” includes not only a situation where the former sloping angle and the latter sloping angle completely correspond but also a situation where the former sloping angle differs from the latter sloping angle by ±3° or less. The former sloping angle may be smaller than the latter sloping angle or may be larger than the latter sloping angle.

The embedded portion 240 of the lead-out portion 22a extends so as to descend from the proximal portion 23 to a central portion of the third side surface 13 in the Z-axis direction. The embedded portion 240 of the lead-out portion 22b extends so as to ascend from the proximal portion 23 to a central portion of the fourth side surface 14 in the Z-axis direction. However, the central portion of the third side surface 13 or the fourth side surface 14 in the Z-axis direction is not limited to a strict center of the third side surface 13 or the fourth side surface 14 in the Z-axis direction but also includes a location upwardly or downwardly apart from the strict center by a predetermined length. The predetermined length is not limited and is a length equivalent to, for example, 10% or less, 8% or less, 5% or less, or 3% or less of the height H of the core 10 shown in FIG. 4A.

The embedded portion 240 extends from the proximal portion 23 to the level of a central portion of the winding portion 21 in the direction perpendicular to the mounting surface 15 (Z-axis direction). The central portion of the winding portion 21 in the Z-axis direction is not limited to a strict center of the winding portion 21 in the Z-axis direction but also includes a location upwardly or downwardly apart from the strict center by a predetermined length. The predetermined length is not limited and is a length equivalent to, for example, 10% or less, 8% or less, 5% or less, or 3% or less of the height of the winding portion 21 along its winding axis direction. In the example shown in FIG. 4A, the embedded portion 240 extends from the proximal portion 23 at the first layer or the third layer of the winding portion 21 to the level of a second layer of the winding portion 21 in the direction perpendicular to the mounting surface 15 (Z-axis direction).

In the present embodiment, the central portion of the winding portion 21 in the Z-axis direction is located at a central portion of the core 10 in the Z-axis direction. However, the central portion of the winding portion 21 in the Z-axis direction may be located at a level above or below the central portion of the core 10 in the Z-axis direction.

The terminal portion 242 continues to the embedded portion 240 and is disposed outside the core 10. The terminal portion 242 extends along the side surface (third side surface 13 or fourth side surface 14) and the mounting surface 15 of the core 10. At the terminal portion 242, the film of the wire 20 is peeled off; and a surface of the terminal portion 242 is not covered with the film of the wire 20. Near the border portion 27b between the embedded portion 240 and the terminal portion 242, the terminal portion 242 is bent with respect to the embedded portion 240 towards the side surface (third side surface 13 or fourth side surface 14) of the core 10. The border portion 27b between the embedded portion 240 and the terminal portion 242 is not disposed inside the core 10 and is exposed from the core 10.

The flattened portion 24 is bent at the border portion 27b between the embedded portion 240 and the terminal portion 242. At the border portion 27b between the embedded portion 240 and the terminal portion 242, the flattened portion 24 may have any radius of curvature. This radius of curvature is larger than the thickness of the flattened portion 24. However, at the border portion 27b between the embedded portion 240 and the terminal portion 242, the radius of curvature of the flattened portion 24 may be equivalent to or smaller than the thickness of the flattened portion 24.

The terminal portion 242 includes the side portion 244 and the mounting portion 246. The side portion 244 continues to the embedded portion 240 and is bent with respect to the embedded portion 240. The side portion 244 is exposed from the core 10 at the central portion of the side surface (third side surface 13 or fourth side surface 14) of the core 10 in the direction perpendicular to the mounting surface 15 (Z-axis direction). The side portion 244 extends along the side surface (third side surface 13 or fourth side surface 14) of the core 10 from the central portion of the side surface (third side surface 13 or fourth side surface 14) of the core 10 to the mounting surface 15.

The side portion 244 is disposed parallel to the side surface (third side surface 13 or fourth side surface 14) of the core 10. In the present embodiment, “parallel” is not limited to a strictly parallel state; and the concept of “parallel” includes a state shifted by not more than several degrees (not limited; e.g., 3 degrees) with respect to the strictly parallel state. Similarly, “perpendicular” is not limited to a strictly perpendicular state; and the concept of “perpendicular” includes a state shifted by not more than several degrees (not limited; e.g., 3 degrees) with respect to the strictly perpendicular state.

The side portion 244 is in contact with the side surface (third side surface 13 or fourth side surface 14) of the core 10. However, it may be that the side portion 244 is not in contact with the side surface of the core 10; and the side portion 244 and the side surface of the core 10 may have a space therebetween. In the example shown in FIG. 4A, the side portion 244 is entirely in contact with the side surface of the core 10; however, the side portion 244 may partly be in contact with the side surface of the core 10.

The length of the side portion 244 along the Z-axis is almost equivalent to half the height H of the core 10. However, “almost equivalent” includes not only a situation where the length of the side portion 244 along the Z-axis completely corresponds to half the height H of the core 10 but also a situation where the length of the side portion 244 along the Z-axis differs from half the height H of the core 10 by ±5% or less.

The side portion 244 extends diagonally with respect to the embedded portion 240. The side portion 244 linearly extends from the border portion 27b between the embedded portion 240 and the terminal portion 242 to the mounting surface 15. However, the side portion 244 may extend, from the border portion 27b between the embedded portion 240 and the terminal portion 242 to the mounting surface 15, with a bend or a curve.

The mounting portion 246 continues to the side portion 244 and extends in a direction orthogonal to the side portion 244. The mounting portion 246 extends along the mounting surface 15. The mounting portion 246 is a portion connectable to a mounting substrate (not shown in the drawings) using a conductive joining material (e.g., solder or a conductive adhesive).

As shown in FIG. 1A, the mounting portion 246 of the lead-out portion 22a is disposed in the second recess 18a recessed from the mounting surface 15. The mounting portion 246 of the lead-out portion 22b is disposed in the second recess 18b recessed from the mounting surface 15. The side portion 244 of the lead-out portion 22a is disposed in the first recess 17a recessed from the third side surface 13. The side portion 244 of the lead-out portion 22b is disposed in the first recess 17b recessed from the fourth side surface 14.

As shown in FIG. 4A, the inner surface 25 and the outer surface 26 of the lead-out portion 22a are provided with a plating layer 30. The inner surface 25 and the outer surface 26 of the lead-out portion 22b are provided with the plating layer 30. The plating layer 30 is formed where the lead-out portion 22a or 22b is exposed from the core 10, i.e., at the terminal portion 242. The plating layer 30 being provided on the outer surface 26 of the terminal portion 242 improves adhesiveness of the joining material (e.g., solder or a conductive adhesive) with respect to the outer surface 26 at the time of mounting the coil device 1 on a substrate or the like. The plating layer 30 may include a single layer or multiple layers. The plating layer 30 is not limited. Examples thereof include Cu plating, Ni plating, Sn plating, Ni—Sn plating, Cu—Ni—Sn plating, Ni—Au plating, Au plating, and Sn—Pb plating (solder plating).

The plating layer 30 is provided on both the inner surface 25 and the outer surface 26 of the terminal portion 242. However, it may be that the plating layer 30 is not provided on the inner surface 25 of the terminal portion 242 (side portion 244 or mounting portion 246) and is provided on the outer surface 26 of the terminal portion 242 (side portion 244 or mounting portion 246). In this situation, the inner surface 25 of the terminal portion 242 (side portion 244 or mounting portion 246) may be covered with the film of the wire 20.

The plating layer 30 is provided on both the side portion 244 and the mounting portion 246 of the terminal portion 242. However, it may be that the plating layer 30 is provided on the mounting portion 246 but not on the side portion 244. In this situation, the side portion 244 may be covered with the film of the wire 20.

The plating layer 30 is not provided on the embedded portion 240, which is, among parts of the flattened portion 24, disposed inside the core 20. The plating layer 30 is not provided on the proximal portion 23, which is disposed inside the core 10. However, the plating layer 30 may be provided on the inner surface 25 and/or the outer surface 26 of the embedded portion 240. The plating layer 30 may be provided on the inner surface 25 and/or the outer surface 26 of the proximal portion 23.

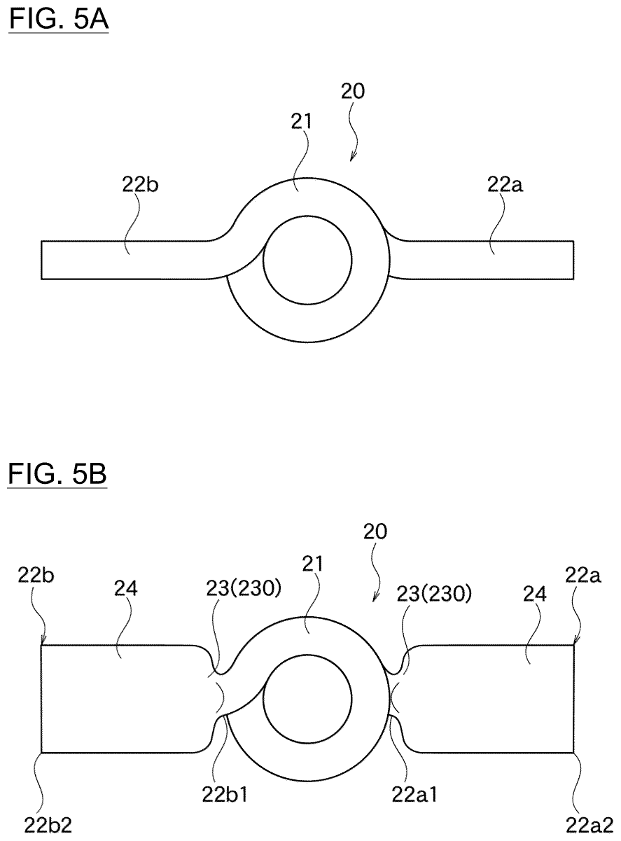

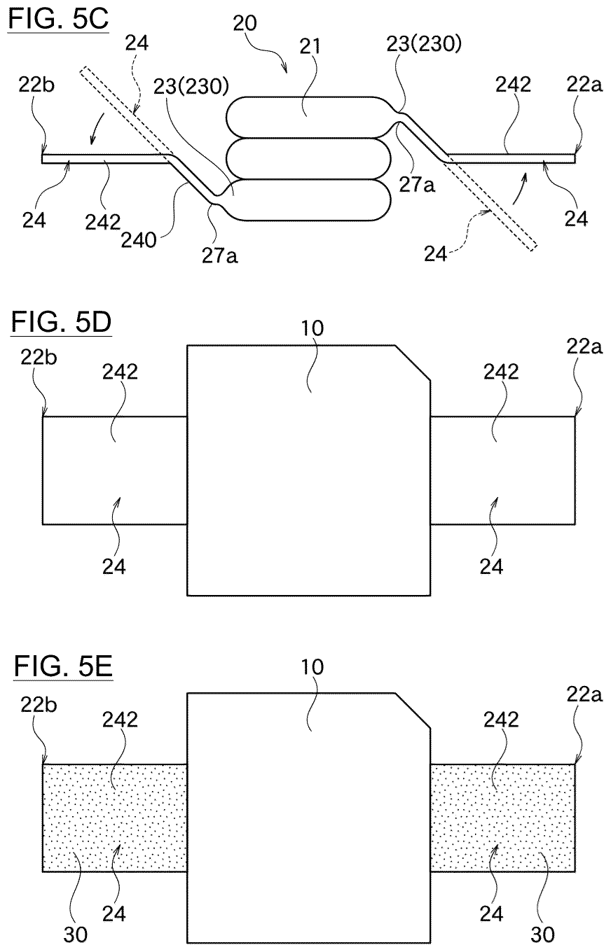

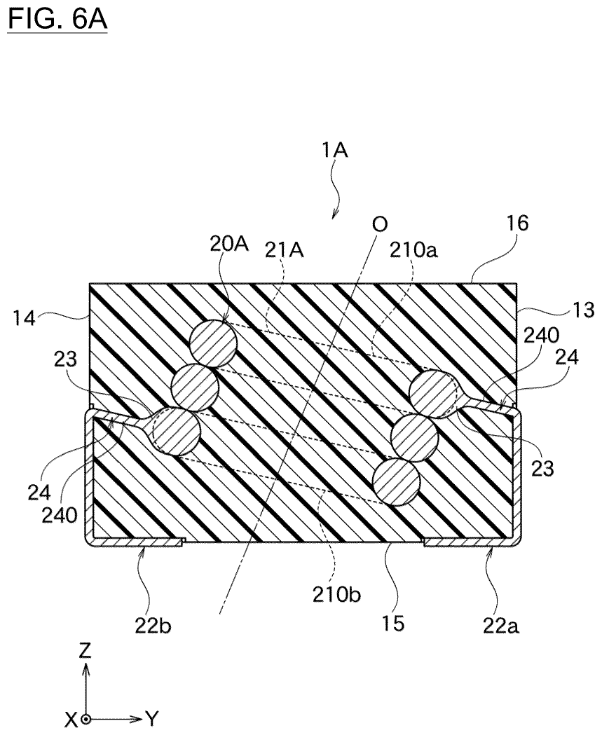

A method of manufacturing the coil device 1 shown in FIG. 1B is described next with reference to FIGS. 5A to 5E and the like. First, as shown in FIG. 5A, the wire 20, which includes the winding portion 21 and the lead-out portions 22a and 22b drawn out from the winding portion 21, is prepared. The wire 20 is a round wire but may be a rectangular wire. The winding portion 21 is an air core coil. The lead-out portions 22a and 22b are drawn out from the winding portion 21 in opposite directions.

Then, as shown in FIG. 5B, the lead-out portion 22a is squeezed to provide the lead-out portion 22a with the flattened portion 24 in a flat shape and the sloping portion 230 (see FIG. 4A) in a sloping shape. The sloping portion 230 has a thickness (thickness between the inner surface 25 and the outer surface 26) that gradually thins from the winding portion 21 to the flattened portion 24. The range of the lead-out portion 22a for squeezing is, for example, from a border portion 22a1 between the winding portion 21 and the lead-out portion 22a to an extremity 22a2 of the lead-out portion 22a. This forms the proximal portion 23, which includes the sloping portion 230 shown in FIG. 4A, near the border portion 22a1 between the winding portion 21 and the lead-out portion 22a. This also forms the flattened portion 24 on a side closer than the proximal portion 23 to the extremity of the lead-out portion 22a.

As shown in FIG. 5B, the lead-out portion 22b is squeezed to provide the lead-out portion 22b with the flattened portion 24 in a flat shape and the sloping portion 230 (see FIG. 4A) in a sloping shape. The sloping portion 230 has a thickness that gradually thins from the winding portion 21 to the flattened portion 24. The range of the lead-out portion 22b for squeezing is, for example, from a border portion 22b1 between the winding portion 21 and the lead-out portion 22b to an extremity 22b2 of the lead-out portion 22b. This forms the proximal portion 23, which includes the sloping portion 230 shown in FIG. 4A, near the border portion 22b1 between the winding portion 21 and the lead-out portion 22b. This also forms the flattened portion 24 on a side closer than the proximal portion 23 to the extremity of the lead-out portion 22b.

Then, as shown in FIG. 5C, the flattened portion 24 of the lead-out portion 22a is bent at two locations. First, at the border portion 27a between the proximal portion 23 and the flattened portion 24, the flattened portion 24 extending horizontally (see FIG. 5B) is bent downwards. This makes, as shown in FIG. 5C, the flattened portion 24 extend diagonally downwards with respect to the proximal portion 23. Also, the flattened portion 24 (a portion shown in broken lines in FIG. 5C) is bent upwards (in a direction shown by an arrow in FIG. 5C) at a location that is, for example, closer to the winding portion 21 than a center of the flattened portion 24 in its extending direction. More specifically, the flattened portion 24 (the portion shown in the broken lines in FIG. 5C) is bent upwards so that this bent portion is perpendicular to the winding axis direction of the winding portion 21. This provides the flattened portion 24 with the embedded portion 240, which slopes with respect to the winding axis direction of the winding portion 21, and the terminal portion 242, which is orthogonal to the winding axis direction of the winding portion 21.

Also, the flattened portion 24 of the lead-out portion 22b is bent at two locations. First, at the border portion 27a between the proximal portion 23 and the flattened portion 24, the flattened portion 24 extending horizontally (see FIG. 5B) is bent upwards. This makes, as shown in FIG. 5C, the flattened portion 24 extend diagonally upwards with respect to the proximal portion 23. Also, the flattened portion 24 (a portion shown in broken lines in FIG. 5C) is bent downwards at a location that is, for example, closer to the winding portion 21 than a center of the flattened portion 24 in its extending direction. More specifically, the flattened portion 24 (the portion shown in the broken lines in FIG. 5C) is bent downwards so that this bent portion is perpendicular to the winding axis direction of the winding portion 21. This provides the flattened portion 24 with the embedded portion 240, which slopes with respect to the winding axis direction of the winding portion 21, and the terminal portion 242, which is orthogonal to the winding axis direction of the winding portion 21.

Then, the wire 20 shown in FIG. 5C is placed in a cavity of a mold (not shown in the drawings), and the cavity is filled with a core material including the magnetic material and the resin. At this time, the cavity is filled with the core material so that the winding portion 21 is embedded in the core material, the embedded portions 240 are embedded in the core material, and the terminal portions 242 are exposed from the core material. Then, the core material with which the cavity is filled is compressed and hardened for a predetermined amount of time at a predetermined mold temperature to give the core 10 shown in FIG. 5D.

Then, for example, the terminal portions 242 exposed from the core 10 are irradiated with a laser to peel the film off from surfaces of the terminal portions 242. Then, as shown in FIG. 5E, the plating layer 30 is formed on the terminal portions 242 exposed from the core 10. In the present embodiment, the plating layer 30 is formed on the inner surface 25 (FIG. 4A) and the outer surface 26 (FIG. 4A) of the terminal portions 242; however, it may be that the plating layer 30 is formed only on the outer surface 26 of the terminal portions 242. The plating layer 30 is not limited. The plating layer 30 is, for example, Sn—Pb plating (solder plating). Any method of forming the plating layer 30 may be used. For example, electroless plating, electrolytic plating, or dipping may be used. Note that the step of forming the plating layer 30 on the terminal portions 242 may be carried out before molding of the core 10 (before the step shown in FIG. 5D).

Then, as shown in FIG. 4A, the terminal portion 242 of the lead-out portion 22a is bent with respect to the embedded portion 240 towards the third side surface 13 of the core 10 (see a part of FIG. 4A in a dashed-and-double-dotted line), near the border portion 27b between the embedded portion 240 and the terminal portion 242. The side portion 244 of the terminal portion 242 is thus disposed along the third side surface 13. Also, the terminal portion 242 of the lead-out portion 22b is bent with respect to the embedded portion 240 towards the fourth side surface 14 of the core 10, near the border portion 27b between the embedded portion 240 and the terminal portion 242. The side portion 244 of the terminal portion 242 is thus disposed along the fourth side surface 14.

Then, an extremity of the terminal portion 242 disposed along the third side surface 13 is bent towards the mounting surface 15 of the core 10. The mounting portion 246 of the terminal portion 242 is thus disposed along the mounting surface 15. Also, an extremity of the terminal portion 242 disposed along the fourth side surface 14 is bent towards the mounting surface 15 of the core 10. The mounting portion 246 of the terminal portion 242 is thus disposed along the mounting surface 15. In the above manner, the coil device 1 can be manufactured.

As shown in FIG. 4A, in the coil device 1 of the present embodiment, each embedded portion 240 extends diagonally from the proximal portion 23 to the side surface (third side surface 13 or fourth side surface 14) of the core 10. Thus, the distance between the embedded portion 240 and the winding portion 21 (the distance along the Y-axis) increases towards the side surface of the core 10 (away from the proximal portion 23) as the embedded portion 240 becomes distant from the winding portion 21. This can prevent a short circuit between the embedded portion 240 and the winding portion 21.

Each terminal portion 242 is exposed from the core 10 at the central portion of the side surface (third side surface 13 or fourth side surface 14) of the core 10 in the direction perpendicular to the mounting surface 15 (Z-axis direction). The terminal portion 242 extends from the central portion of the side surface of the core 10 to the mounting surface 15. Thus, the area of the terminal portion 242 (i.e., side portion 244) disposed at the side surface of the core 10 is readily provided, and a solder fillet is readily formed at the terminal portion 242 (i.e., side portion 244) disposed at the side surface of the core 10. This can ensure mounting strength of the coil device 1.

In a situation where the terminal portion 242 is exposed from the core 10 at the central portion of the side surface (third side surface 13 or fourth side surface 14) of the core 10, the terminal portion 242 is more readily bent with respect to the embedded portion 240 towards the side surface of the core 10 compared to a situation where the terminal portion 242 is exposed from the core 10 at a lower part of the side surface of the core 10. This can simplify manufacture of the coil device 1. Also, in the situation where the terminal portion 242 is exposed from the core 10 at the central portion of the side surface of the core 10, DC resistance of the coil device 1 can be decreased compared to a situation where the terminal portion 242 is exposed from the core 10 at an upper part of the side surface of the core 10.

The embedded portion 240 extends from the proximal portion 23 to the level of the central portion of the winding portion 21 in the direction perpendicular to the mounting surface 15 (Z-axis direction). Thus, the wire 20 (winding portion 21) has a stable center of gravity. This can prevent misalignment of the wire 20 when, for example, the wire 20 is placed in a mold for compression molding in a manufacturing step of the coil device 1.

The embedded portion 240 extends diagonally from the proximal potion 23 to the side surface (third side surface 13 or fourth side surface 14) of the core 10 without a bend at a right angle. Thus, DC resistance of the coil device 1 can be decreased. Also, damage to the embedded portion 240 attributed to a bend can be prevented.

The proximal portion 23 includes the sloping portion 230. In the section perpendicular to the mounting surface 15 and the third side surface 13 (YZ section), the sloping portion 230 thins towards the flattened portion 24. Providing the proximal portion 23 with the sloping portion 230 enables DC resistance of the coil device 1 to be decreased compared to a situation where the proximal portion 23 is not provided with the sloping portion 230 (i.e., a situation where the proximal portion 23 thins rapidly or sharply at the border portion 27a between the proximal portion 23 and the flattened portion 24).

The lead-out portion 22a or 22b is bent at the border portion 27a between the proximal portion 23 and the flattened portion 24 and has a radius of curvature that is larger than the thickness of the flattened portion 24 at the border portion 27a. Thus, the embedded portion 240 is readily drawn out diagonally from the proximal portion 23 to the side surface (third side surface 13 or fourth side surface 14) of the core 10 so that the embedded portion 240 becomes distant from the winding portion 21 towards the side surface of the core 10 (away from the proximal portion 23). Thus, the distance between the embedded portion 240 and the winding portion 21 is readily ensured, which can effectively prevent a short circuit between the embedded portion 240 and the winding portion 21.

The wire 20 is a round wire or an edgewise wound rectangular wire (round wire in the present embodiment), and the winding portion 21 includes the insulating coating. Thus, the lead-out portion 22a or 22b is readily squeezed flat, and the flattened portion 24 is readily formed there. Also, the insulating coating can insulate the winding portion 21 from the magnetic material of the core 10.

Viewed from the direction perpendicular to the mounting surface 15 (Z-axis direction), the winding portion 21 has a circular outer circumferential shape. Thus, in a situation where the core 10 includes the first side surface 11 and the second side surface 12 facing each other in the X-axis direction and the third side surface 13 and the fourth side surface 14 facing each other in the Y-axis direction as shown in FIG. 1A, the following effect can be produced. That is, in this situation, as shown in FIG. 3, viewed from the direction perpendicular to the mounting surface 15, the distance between an outer circumferential surface of the winding portion 21 and the first side surface 11 along the X-axis direction and the distance between the outer circumferential surface of the winding portion 21 and the second side surface 12 along the X-axis direction tend to be the same. Also, the distance between the outer circumferential surface of the winding portion 21 and the third side surface 13 along the Y-axis direction and the distance between the outer circumferential surface of the winding portion 21 and the fourth side surface 14 along the Y-axis direction tend to be the same. Consequently, the volume of the core 10 with which a space between the outer circumferential surface of the winding portion 21 and the first side surface 11 is filled and the volume of the core 10 with which a space between the outer circumferential surface of the winding portion 21 and the second side surface 12 is filled tend to be the same. Also, the volume of the core 10 with which a space between the outer circumferential surface of the winding portion 21 and the third side surface 13 is filled and the volume of the core 10 with which a space between the outer circumferential surface of the winding portion 21 and the fourth side surface 14 is filled tend to be the same. This can improve inductance properties of the coil device 1.

Also, in the present embodiment, as shown in FIG. 5C, the flattened portion 24 is subject to forming before the step of compression molding of the core material (FIG. 5D) so that the embedded portion 240 having a sloping shape is formed at the flattened portion 24. Placing the wire 20 having been subject to forming in this manner in a mold and carrying out compression molding of the core material in the mold can effectively prevent misalignment of the wire 20 at the time of compression molding.

### Second Embodiment

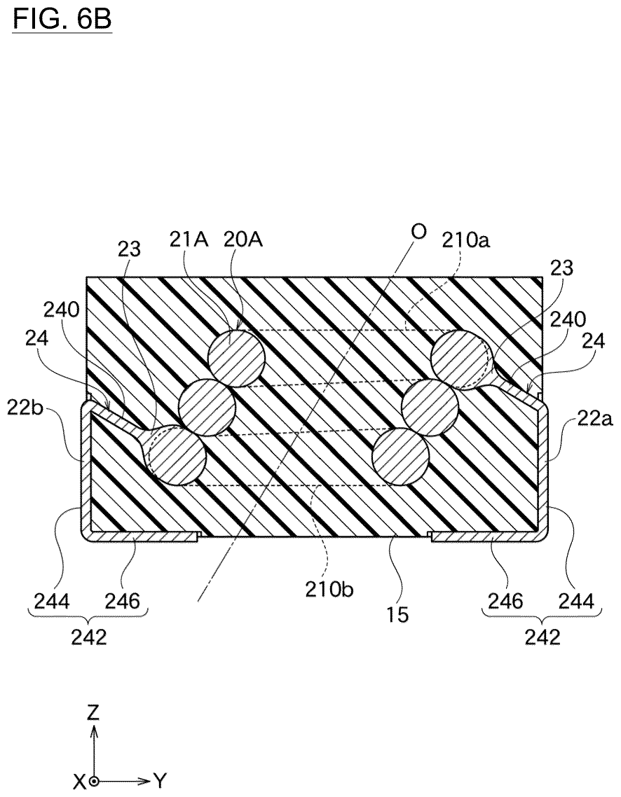

A coil device 1A of a second embodiment shown in FIG. 6A has structures similar to those of the coil device 1 of the first embodiment except for the following. Parts common to the coil device 1 of the first embodiment are given the same reference numerals, and their detailed description is omitted.

The coil device 1A includes a wire 20A. The wire 20A includes a winding portion 21A. An extending direction of a winding axis O of the winding portion 21A (a winding axis direction of the winding portion 21A) slopes with respect to a direction perpendicular to a mounting surface 15 (Z-axis direction). The winding axis direction of the winding portion 21A slopes with respect to a side surface (third side surface 13 or fourth side surface 14) or a core 10. The winding axis direction of the winding portion 21A slopes with respect to the mounting surface 15 and an opposite mounting surface 16.

A sloping angle θ at which the winding axis direction of the winding portion 21A slopes with respect to the direction perpendicular to the mounting surface 15 (Z-axis direction) is not limited. The sloping angle is, for example, 0°<θ≤70°, 5°≤θ≤60°, or 10°≤θ≤50°. The same applies to a sloping angle θ at which the winding axis direction of the winding portion 21A slopes with respect to the side surface (third side surface 13 or fourth side surface 14) of the core 10.

In the present embodiment, a top surface 210a of the winding portion 21A slopes with respect to the mounting surface 15. A bottom surface 210b of the winding portion 21A slopes with respect to the mounting surface 15. However, the top surface 210a of the winding portion 21A may be parallel to the mounting surface 15 as shown in FIG. 6B. The bottom surface 210b of the winding portion 21A may also be parallel to the mounting surface 15.

As shown in FIG. 6A, an embedded portion 240 is drawn out diagonally from a proximal potion 23 to a central portion of the side surface (third side surface 13 or fourth side surface 14) of the core 10 in the Z-axis direction. An extending direction of the embedded portion 240 is orthogonal to the winding axis direction of the winding portion 21A. In the present embodiment, “orthogonal” is not limited to a strict orthogonal state (i.e., the extending direction of the embedded portion 240 meeting the winding axis direction of the winding portion 21A at 90°; and the concept of “orthogonal” includes a state shifted by not more than several degrees (not limited; e.g., 3 degrees) with respect to the strict orthogonal state.

In the present embodiment, effects similar to those of the first embodiment can be produced as well. In addition, in the present embodiment, the winding axis direction of the winding portion 21A slopes with respect to the direction perpendicular to the mounting surface 15 (Z-axis direction). Thus, without the embedded portion 240 being bent diagonally with respect to the proximal portion 23 (or, even if the angle at which the embedded portion 240 is bent with respect to the proximal portion 23 is small), the embedded portion 240 can slope towards the side surface (third side surface 13 or fourth side surface 14) of the core 10 according to the sloping angle of the winding axis direction of the winding portion 21A. This enables the embedded portion 240 to extend diagonally from the proximal portion 23 to the side surface of the core 10. Thus, a distance between the embedded portion 240 and the winding portion 21A (distance along the Y-axis) is provided, which can prevent a short circuit between the embedded portion 240 and the winding portion 21A.

Also, according to the sloping angle of the winding axis direction of the winding portion 21A, the embedded portion 240 can slope towards the side surface (third side surface 13 or fourth side surface 14) of the core 10 so that a terminal portion 242 is exposed from the core 10 at the central portion of the side surface of the core 10. The terminal portion 242 can thus be disposed from the central portion of the side surface of the core 10 to the mounting surface 15 in the direction perpendicular to the mounting surface 15 (Z-axis direction). Thus, the area of the terminal portion 242 (i.e., the area of a side portion 244) disposed at the side surface of the core 10 is readily provided, and a solder fillet is readily formed at the terminal portion 242 (side portion 244) disposed at the side surface of the core 10. This can ensure mounting strength of the coil device 1A.

The present disclosure is not limited to the above embodiments and can variously be modified within the scope of the present disclosure.

In the description of the above embodiments, examples of applying the present disclosure to an inductor are illustrated; however, the present disclosure may be applied to other coil devices.

In the above embodiments, the entire region, from one end to the other end in the extending direction, of the embedded portion 240 shown in FIG. 4A and the like extends diagonally from the proximal portion 23 to the side surface (third side surface 13 or fourth side surface 14) of the core 10. However, the entire region of the embedded portion 240 in the extending direction may not necessarily extend diagonally from the proximal portion 23 to the side surface of the core 10. For example, the embedded portion 240 may include, somewhere from the one end to the other end of the embedded portion 240 in the extending direction, a portion that does not extend diagonally from the proximal portion 23 to the side surface of the core 10. That is, at least a part of the embedded portion 240 in the extending direction may extend diagonally from the proximal portion 23 to the side surface of the core 10.

### REFERENCE NUMERALS

1, 1A . . . coil device
10 . . . core
11 . . . first side surface
12 . . . second side surface
13 . . . third side surface
14 . . . fourth side surface
15 . . . mounting surface
16 . . . opposite mounting surface
17a, 17b . . . first recess
18a, 18b . . . second recess
19 . . . chamfered portion
20, 20A . . . wire
21, 21A . . . winding portion
210a . . . top surface
210b . . . bottom surface
22a, 22b . . . lead-out portion
22a2, 22b2 . . . extremity
23 . . . proximal portion
230 . . . sloping portion
231a, 231b . . . sloping surface
232 . . . non-sloping portion
24 . . . flattened portion
240 . . . embedded portion
242 . . . terminal portion
244 . . . side portion
246 . . . mounting portion
25 . . . inner surface
26 . . . outer surface
27a, 27b, 22a1, 22b1 . . . border portion
30 . . . plating layer

What is claimed is:

1. A coil device comprising:
a core comprising a magnetic material and comprising a mounting surface and a side surface extending in a direction perpendicular to the mounting surface; and
a wire comprising a winding portion disposed inside the core and a lead-out portion drawn out from the winding portion,
wherein
the lead-out portion comprises a proximal portion continuing to the winding portion and a flattened portion continuing to the proximal portion and being squeezed flat;
the flattened portion comprises an embedded portion disposed inside the core and a terminal portion having a plating layer and being disposed outside the core;
the embedded portion extends diagonally from the proximal portion to the side surface;
the terminal portion is exposed from the core at a central portion of the side surface in the direction perpendicular to the mounting surface; and
the terminal portion extends from the central portion of the side surface to the mounting surface.

2. The coil device according to claim 1, wherein the embedded portion extends from the proximal portion to a level of a central portion of the winding portion in the direction perpendicular to the mounting surface.

3. The coil device according to claim 1, wherein the embedded portion extends diagonally from the proximal portion to the side surface without a bend at a right angle.

4. The coil device according to claim 1, wherein
the proximal portion comprises a sloping portion; and
the sloping portion thins towards the flattened portion in a section perpendicular to the mounting surface and the side surface.

5. The coil device according to claim 1, wherein
the lead-out portion is bent at a border portion between the proximal portion and the flattened portion; and
the lead-out portion has a radius of curvature larger than a thickness of the flattened portion at the border portion.

6. The coil device according to claim 1, wherein
the wire comprises a round wire or an edgewise wound rectangular wire; and
the winding portion comprises an insulating coating.

7. The coil device according to claim 1, wherein the winding portion has a circular outer circumferential shape viewed from the direction perpendicular to the mounting surface.

8. The coil device according to claim 1, wherein a winding axis direction of the winding portion slopes with respect to the direction perpendicular to the mounting surface.
